(19) United States
(12) Patent Application Publication
(10) Pub. No.: US 2024/0170832 A1
(43) Pub. Date: May 23, 2024

(54) MULTI-ANTENNA SYSTEM AND WIRELESS COMMUNICATION DEVICE

(71) Applicant: Honor Device Co., Ltd., Shenzhen (CN)

(72) Inventors: Yiwu Hu, Shenzhen (CN); Kunpeng Wei, Shenzhen (CN); Aofang Zhang, Shenzhen (CN); Qiao Guan, Shenzhen (CN)

(21) Appl. No.: 18/550,029

(22) PCT Filed: Aug. 15, 2022
(86) PCT No.: PCT/CN2022/112393

§ 371 Date: Sep. 11, 2023

(30) Foreign Application Priority Data
Sep. 7, 2021 (CN) 202111045126.7

(51) Int. Cl. H01Q 1/24; H01Q 1/48; H01Q 1/52; H01Q 21/06

(52) U.S. Cl. CPC H01Q 1/243; H01Q 1/48; H01Q 1/523; H01Q 21/06

(57) ABSTRACT

This application discloses a multi-antenna system and a wireless communication device. The multi-antenna system includes a first antenna, a second antenna. A first extension branch is close to the second antenna, and a second extension branch is close to the first antenna. A feed of the first antenna is disposed on the first radiator, and a feed of the second antenna is disposed on a second radiator. A feed of the third antenna is disposed at the first extension branch. There is a spacing between the first extension branch and the second extension branch. An equivalent circuit of the spacing includes a distributed capacitor. The distributed capacitor is configured to isolate signal coupling between the first antenna and the second antenna when a first resonant frequency of the first antenna and a second resonant frequency of the second antenna are within a preset frequency range.

### CROSS-REFERENCE TO RELATED APPLICATIONS

This application is a national stage of International Application No. PCT/CN2022/112393, filed on Aug. 15, 2022, which claims priority to Chinese Patent Application No. 202111045126.7, filed on Sep. 7, 2021. The disclosures of both of the aforementioned applications are hereby incorporated by reference in their entireties.

### TECHNICAL FIELD

This application relates to the field of antenna technologies of terminal devices, and in particular, to a multi-antenna system and a wireless communication device.

### BACKGROUND

With continuous development of terminals, the terminals have an increasingly high requirement for built-in antennas, for example, requiring the antennas to be miniaturized gradually, and communication efficiency is increasingly high. For example, signals need to be sent and received through an antenna to make a phone call or access the Internet. However, after antenna miniaturization, a radiator of an antenna also becomes smaller, leading to a narrowing frequency range covered by the antenna of a terminal.

After antenna miniaturization, to improve a frequency range covered by antennas, a plurality of antennas are usually built into a terminal to form an antenna system. For example, the antenna system may include a first antenna and a second antenna, where a frequency range covered by the first antenna is 2.4 GHz to 2.5 GHZ, and a frequency range covered by the second antenna is 2.5 GHz to 2.7 GHZ. It can be learned that, compared with an antenna system with a single antenna (for example, an antenna system including only the first antenna or only the second antenna), the antenna system includes a plurality of antennas, and therefore can cover a wider frequency range.

However, when the first antenna and the second antenna operate on adjacent frequencies or a same frequency, there is signal interference, that is, signal coupling, between the first antenna and the second antenna. This reduces communication efficiency of the antenna system.

### SUMMARY

To resolve the foregoing technical problems, this application provides a multi-antenna system and a wireless communication device, to weaken interference between multiple antennas and improve communication efficiency of the multi-antenna system.

According to a first aspect, this application provides a multi-antenna system. The multi-antenna system is applied to a wireless communication device, and includes a first antenna, a second antenna, and a third antenna disposed at frame positions of the wireless communication device. In some possible implementations, the third antenna and the first antenna share a first radiator of the first antenna, and the first radiator includes a first extension branch that is close to the second antenna. A second radiator includes a second extension branch that is close to the first antenna. A ground of the first antenna is disposed at the first extension branch. A ground of the second antenna is disposed at the second extension branch. A feed of the first antenna is disposed on the first radiator and far away from one end of the second antenna, and a feed of the second antenna is disposed on the second radiator and far away from one end of the first antenna. A feed of the third antenna is disposed at the first extension branch.

In some other possible implementations, the third antenna and the second antenna share the second radiator of the second antenna. Similarly, the feed of the third antenna is disposed at the second extension branch.

The multi-antenna system reduces interference between the first antenna and the second antenna through a distributed capacitor of an equivalent circuit formed by the third antenna, so that communication efficiency of the multi-antenna system is improved. Specifically, there is a spacing between the first extension branch and the second extension branch. An equivalent circuit of the spacing includes the distributed capacitor. The distributed capacitor can isolate signal coupling between the first antenna and the second antenna when a first resonant frequency of the first antenna and a second resonant frequency of the second antenna are within a preset frequency range. A capacitance of the distributed capacitor is inversely proportional to a frequency within the preset frequency range. For example, when the first antenna and the second antenna operate on adjacent frequencies or a same frequency, the distributed capacitor can reduce the signal coupling between the first antenna and the second antenna, thereby weakening mutual interference between signals and improving communication efficiency of the multi-antenna system.

Optionally, the third antenna may excite double resonance through bias feeding, to enable the multi-antenna system to cover a wider frequency range.

Optionally, the feed of the third antenna is located between the ground of the first antenna and the ground of the second antenna, the third antenna and the first antenna share the ground of the first antenna, and the third antenna and the second antenna share the ground of the second antenna.

Optionally, the capacitance of the distributed capacitor is inversely proportional to the spacing between the first extension branch and the second extension branch. To be specific, a larger spacing between the first extension branch and the second extension branch indicates a smaller capacitance of the distributed capacitor, and a smaller spacing between the first extension branch and the second extension branch indicates a larger capacitance of the distributed capacitor.

Optionally, the capacitance of the distributed capacitor is directly proportional to a coupling area of the first extension branch and the second extension branch. To be specific, a larger coupling area of the first extension branch and the second extension branch indicates a larger capacitance of the distributed capacitor, and a smaller coupling area of the first extension branch and the second extension branch indicates a smaller capacitance of the distributed capacitor.

Optionally, the equivalent circuit further includes a distributed inductor, and the distributed capacitor and the distributed inductor form a band-stop circuit. The and-stop circuit can reduce signal coupling between the first antenna and the second antenna. In this way, the band-stop circuit can effectively reduce energy emitted by the second antenna and received by the first antenna, to improve isolation between the first antenna and the second antenna.

Optionally, the feeds of the first antenna, the second antenna, and the third antenna use a direct feeding manner or a capacitive coupling feeding manner.

Optionally, the first antenna, the second antenna, and the third antenna are any one of the following:
an inverted-F antenna IFA, a composite right/left-handed CRLH antenna, and a loop antenna, where the first antenna, the second antenna, and the third antenna are implemented in at least one of the following forms:
a metal-frame antenna, a microstrip antenna MDA, a printed circuit board PCB antenna, or a flexible printed circuit board FPC antenna.

Optionally, the double resonance of the third antenna covers frequency ranges of 5.1 GHz to 5.8 GHz and 5.9 GHz to 7.1 GHz.

According to a second aspect, this application provides a wireless communication device, including the multi-antenna system in any optional implementation of the first aspect. The multi-antenna system is configured to send and receive signals when the wireless communication device performs wireless communication. For example, the multi-antenna system can send a signal, receive a signal, and so on when the wireless communication device performs wireless communication.

It can be learned from the foregoing technical solutions that, this application has at least the following advantages:

The multi-antenna system provided in this application is applied to the wireless communication device, and is configured to send and receive wireless signals. The multi-antenna system includes the first antenna, the second antenna, and the third antenna disposed at the frame positions of the wireless communication device. Moreover, the third antenna and the first antenna share the first radiator of the first antenna, or the third antenna and the second antenna share the second radiator of the second antenna. The multi-antenna system reduces interference between the first antenna and the second antenna through a distributed capacitor of an equivalent circuit formed by the third antenna, so that communication efficiency of the multi-antenna system is improved. Specifically, the first radiator includes the first extension branch that is close to the second antenna. The second radiator includes the second extension branch that is close to the first antenna. The ground of the first antenna is disposed at the first extension branch. The ground of the second antenna is disposed at the second extension branch.

The feed of the first antenna is disposed on the first radiator and far away from one end of the second antenna, and the feed of the second antenna is disposed on the second radiator and far away from one end of the first antenna. The feed of the third antenna is disposed at the first extension branch or the second extension branch. There is the spacing between the first extension branch and the second extension branch. The distributed capacitor in the equivalent circuit of the spacing isolates the signal coupling between the first antenna and the second antenna when the first resonant frequency of the first antenna and the second resonant frequency of the second antenna are within the preset frequency range. The capacitance of the distributed capacitor is inversely proportional to the frequency within the preset frequency range. For example, when the first antenna and the second antenna operate on adjacent frequencies or a same frequency, the distributed capacitor can reduce the signal coupling between the first antenna and the second antenna, thereby weakening mutual interference between signals and improving communication efficiency of the multi-antenna system.

### BRIEF DESCRIPTION OF THE DRAWINGS

FIG. 1A is a schematic diagram of an application scenario of a multi-antenna system according to an embodiment of this application;

FIG. 1B is another schematic diagram of an application scenario of a multi-antenna system according to an embodiment of this application;

FIG. 2 is a schematic diagram of a multi-antenna system according to an embodiment of this application;

FIG. 3A is a schematic diagram of an equivalent circuit according to an embodiment of this application;

FIG. 3B is another schematic diagram of an equivalent circuit according to an embodiment of this application;

FIG. 4 is a graph showing variation of isolation between a first antenna and a second antenna according to an embodiment of this application;

FIG. 5A is a current distribution diagram of a third antenna according to an embodiment of this application;

FIG. 5B is another current distribution diagram of a third antenna according to an embodiment of this application;

FIG. 6A is a schematic diagram of a multi-antenna system according to an embodiment of this application;

FIG. 6B is another schematic diagram of a multi-antenna system according to an embodiment of this application;

FIG. 6C is still another schematic diagram of a multi-antenna system according to an embodiment of this application;

FIG. 6D is yet another schematic diagram of a multi-antenna system according to an embodiment of this application;

FIG. 7 is another schematic diagram of a multi-antenna system according to an embodiment of this application;

FIG. 8 is still another schematic diagram of a multi-antenna system according to an embodiment of this application;

FIG. 9A is a graph showing variation of isolation between a first antenna and a second antenna according to an embodiment of this application;

FIG. 9B is another graph showing variation of isolation between a first antenna and a second antenna according to an embodiment of this application;

FIG. 9C is still another graph showing variation of isolation between a first antenna and a second antenna according to an embodiment of this application;

FIG. 10 is another graph showing variation of isolation between a first antenna and a second antenna according to an embodiment of this application;

FIG. 11 is a schematic diagram of a coupling surface of a first extension branch and a second extension branch according to an embodiment of this application;

FIG. 12 is a schematic diagram of a metal-frame antenna according to an embodiment of this application;

FIG. 13A is a schematic diagram showing a parameter S and antenna efficiency of a third antenna according to an embodiment of this application;

FIG. 13B is a schematic diagram showing a return loss of a third antenna according to an embodiment of this application;

FIG. 13C is a current distribution diagram of a third antenna according to an embodiment of this application;

FIG. 13D is another current distribution diagram of a third antenna according to an embodiment of this application;

FIG. 14A is a schematic diagram showing a parameter S and antenna efficiency of a first antenna according to an embodiment of this application;

FIG. 14B is a current distribution diagram of a first antenna according to an embodiment of this application;

FIG. 14C is another current distribution diagram of a first antenna according to an embodiment of this application;

FIG. 15A is a schematic diagram showing a parameter S and antenna efficiency of a second antenna according to an embodiment of this application;

FIG. 15B is a current distribution diagram of a second antenna according to an embodiment of this application;

FIG. 15C is a far-field radiation pattern of a second antenna according to an embodiment of this application;

FIG. 16 is a schematic diagram of a flexible printed circuit board antenna according to an embodiment of this application;

FIG. 17A is another schematic diagram of a parameter S and antenna efficiency of a third antenna according to an embodiment of this application;

FIG. 17B is another current distribution diagram of a third antenna according to an embodiment of this application;

FIG. 17C is another current distribution diagram of a third antenna according to an embodiment of this application;

FIG. 18A is another schematic diagram showing a parameter S and antenna efficiency of a first antenna according to an embodiment of this application;

FIG. 18B is another current distribution diagram of a first antenna according to an embodiment of this application;

FIG. 18C is still another current distribution diagram of a first antenna according to an embodiment of this application;

FIG. 19A is another schematic diagram showing a parameter S and antenna efficiency of a second antenna according to an embodiment of this application;

FIG. 19B is another current distribution diagram of a second antenna according to an embodiment of this application; and

FIG. 19C is another far-field radiation pattern of a second antenna according to an embodiment of this application.

### DETAILED DESCRIPTION OF ILLUSTRATIVE EMBODIMENTS

The following describes the technical solutions in embodiments of this application with reference to the accompanying drawings in embodiments of this application.

The words “first” and “second” in the following descriptions are only used for descriptive purposes, and cannot be understood as indicating or implying relative importance or implicitly indicating the number of indicated technical features. Therefore, features defined as “first”, “second”, and the like may explicitly or implicitly include one or more of these features. In the descriptions of this application, unless otherwise specified, “multiple” means two or more.

In this application, unless otherwise specified and limited, the term “connection” should be broadly understood. For example, “connection” may be a fixed connection, a detachable connection, or an integrated one; or may be a direct connection or an indirect connection through an intermediary. In addition, the term “coupling” may be a way to implement an electrical connection of signal transmission. “Coupling” may be a direct electrical connection or an indirect electrical connection through an intermediary.

With development of antenna technologies, antennas are gradually miniaturized. After antenna miniaturization, to improve a frequency range covered by an antenna system of a terminal, multiple antennas are usually introduced into the antenna system. In some examples, the antenna system may include a first antenna and a second antenna, where a frequency range covered by the first antenna is 2.4 GHz to 2.5 GHZ, and a frequency range covered by the second antenna is 2.5 GHz to 2.7 GHZ. However, for a terminal with limited design space, when the first antenna and the second antenna work in adjacent frequency ranges or a same frequency range, there is serious mutual coupling between the first antenna and the second antenna. The frequency ranges covered by the first antenna and the second antenna are adjacent, and there is a common frequency (2.5 GHZ). Therefore, there is mutual interference between the first antenna and the second antenna, which reduces efficiency of the antenna system.

To solve the foregoing technical problems, an embodiment of this application provides a multi-antenna system. The multi-antenna system is applied to a wireless communication device, and includes a first antenna, a second antenna, and a third antenna disposed at frame positions of the wireless communication device. The third antenna and the first antenna share a first radiator of the first antenna, or the third antenna and the second antenna share a second radiator of the second antenna. The first radiator includes a first extension branch that is close to the first antenna. The second radiator includes a second extension branch that is close to the first antenna. A ground of the first antenna is disposed at the first extension branch. A ground of the second antenna is disposed at the second extension branch. A feed of the first antenna is disposed on the first radiator and far away from one end of the second antenna, and a feed of the second antenna is disposed on the second radiator and far away from one end of the first antenna. A feed of the third antenna is disposed at the first extension branch or the second extension branch. There is a spacing between the first extension branch and the second extension branch, and an equivalent capacitor of the spacing includes a distributed capacitor. The distributed capacitor is configured to isolate signal coupling between the first antenna and the second antenna when a first resonant frequency of the first antenna and a second resonant frequency of the second antenna are within a preset range, and a capacitance of the distributed capacitor is inversely proportional to a frequency within the preset frequency range.

In this way, in the multi-antenna system, when multiple antennas operate in adjacent frequency ranges or a same frequency range, the distributed capacitor can reduce signal coupling between the multiple antennas, thereby weakening mutual interference between the multiple antennas and improving efficiency of the multi-antenna system.

To make a person skilled in the art better understand the technical solution provided in embodiment of this application, an application scenario of the technical solution is introduced with reference to the accompanying drawings.

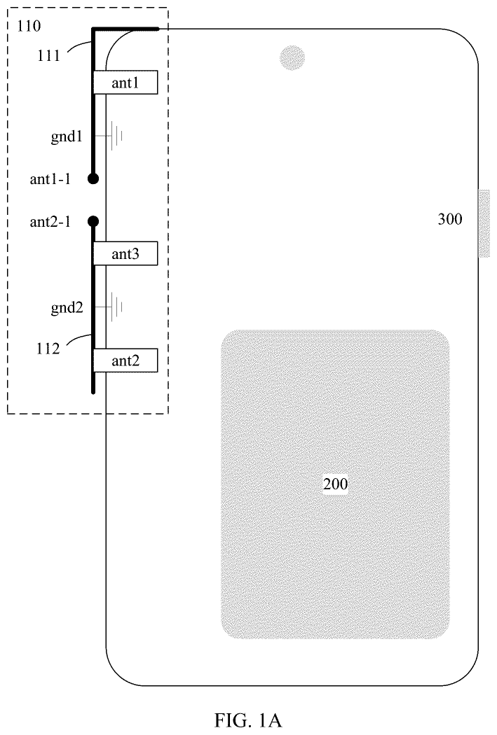

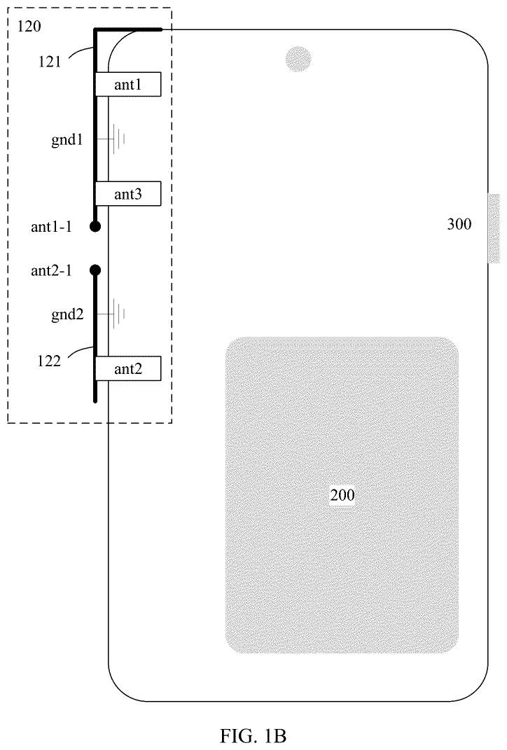

Embodiments of this application do not specifically limit the application scenario of the multi-antenna system. In some possible embodiments, the multi-antenna system may be applied to a wireless communication device, including but not limited to a mobile phone, a tablet computer, a desktop computer, a laptop, a notebook computer, an ultra-mobile personal computer (Ultra-Mobile Personal Computer, UMPC), a handheld computer, a netbook, a personal digital assistant (Personal Digital Assistant, PDA), a wearable mobile terminal, and a smart watch. For ease of understanding, FIG. 1A is a schematic diagram of a multi-antenna system applied to a mobile phone.

As shown in FIG. 1A, the mobile phone includes a multi-antenna system 110, a battery 200, and a side key 300. The multi-antenna system 110 includes a first antenna ant1, a second antenna ant2, and a third antenna ant3 arranged at frame positions of a wireless communication device (such as the mobile phone). The battery 200 is configured to supply power to the mobile phone. The side key 300 is used by the mobile phone to receive user's instructions. For example, the user can press and hold the side key 300 for turning on or off the mobile phone.

In the multi-antenna system 110, the third antenna ant3 and the second antenna ant2 share a second radiator (as shown by 112 in FIG. 1A) of the second antenna ant2. In other words, the third antenna ant3 and the second antenna ant2 are used as a whole. The second radiator includes a second extension branch ant2-1 that is close to the first antenna ant1. Similarly, a first radiator (as shown by 111 in FIG. 1A) includes a first extension branch ant1-1 that is close to the second antenna ant2. A ground of the first antenna ant1 is disposed at the first extension branch ant1-1, and a ground of the second antenna ant2 is disposed at the second extension branch ant2-1. A feed of the first antenna ant1 is disposed on the first radiator 111 and far away from one end of the second antenna ant2, and a feed of the second antenna ant2 is disposed on the second radiator 112 and far away from one end of the first antenna. A feed of the third antenna ant3 is disposed at the second extension branch ant2-1. There is a spacing between the first extension branch ant1-1 and the second extension branch ant2-1. An equivalent circuit of the spacing includes the distributed capacitor. The distributed capacitor can isolate signal coupling between the first antenna ant1 and the second antenna ant2 when a first resonant frequency of the first antenna ant1 and a second resonant frequency of the second antenna ant2 are within a preset frequency range. A capacitance of the distributed capacitor is inversely proportional to a frequency within the preset frequency range. In this way, the multi-antenna system 110 can reduce mutual interference between multiple antennas and improve efficiency. Further, the mobile phone equipped with the multi-antenna system 110 can not only cover a wide frequency range, but also improve communication efficiency.

As shown in FIG. 1B, FIG. 1B is another schematic diagram of a multi-antenna system applied to a mobile phone. The multi-antenna system 120 of the mobile phone shown in FIG. 1B is different from the multi-antenna system 110 of the mobile phone shown in FIG. 1A in that, in the multi-antenna system 120, the third antenna ant3 and the first antenna ant1 share the first radiator of the first antenna ant1 (refer to 121 in FIG. 1B), that is, the third antenna ant3 and the first antenna ant1 are used as a whole. It can be learned from FIG. 1B that, the feed of the third antenna ant3 is disposed at the first extension branch ant1-1. For a specific principle, refer to the descriptions of FIG. 1A. Details are not described herein again.

It should be noted that a person skilled in the art can choose the third antenna ant3 and the first antenna ant1 as a whole, or the third antenna ant3 and the second antenna ant2 as a whole based on actual needs. This is not limited in embodiments of this application.

To make a person skilled in the art better understand the technical solutions provided in embodiments of this application, the following descriptions are provided by using an example of a multi-antenna system in which the third antenna ant3 and the second antenna ant2 are used as a whole.

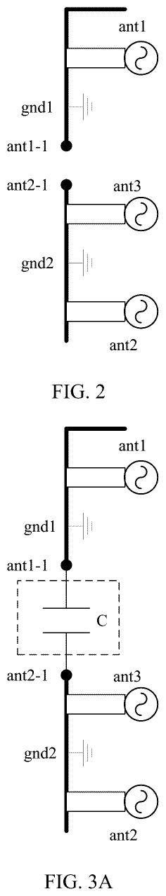

FIG. 2 is a schematic diagram of a multi-antenna system according to an embodiment of this application.

The multi-antenna system includes a first antenna ant1, a second antenna ant2, and a third antenna ant3. The third antenna ant3 and the second antenna ant2 share a second radiator 112 of the second antenna. The second radiator includes a second extension branch ant1-1 that is close to the first antenna ant2. Similarly, a first radiator 111 includes a first extension branch ant1-1 that is close to the second antenna ant2. It can be learned from FIG. 2 that, a ground gnd1 of the first antenna is disposed at the first extension branch ant1-1, and a ground gnd2 of the second antenna ant2 is disposed at the second extension branch ant2-1. A feed of the first antenna is disposed on the first radiator 111 and far away from one end of the second antenna ant2, and a feed of the second antenna ant2 is disposed on the second radiator 112 and far away from one end of the first antenna ant1.

In some embodiments, a feed of the third antenna ant3 is located at the second extension branch ant2-1, and the feed of the third antenna ant3 is located between the ground gnd1 of the first antenna ant1 and the ground gnd2 of the second antenna ant2.

Certainly, in some other embodiments, when the third antenna ant3 and the first antenna ant1 are used as a whole, the feed of the third antenna ant3 is located at the first extension branch ant1-1, and the feed of the third antenna ant3 is located between the ground gnd1 of the first antenna and the ground gnd2 of the second antenna.

The third antenna ant3 and the first antenna ant1 share the ground gnd1 of the first antenna ant1, and the third antenna ant3 and the second antenna ant2 share the ground gnd2 of the second antenna ant2.

There is a spacing between the first extension branch ant1-1 and the second extension branch ant2-1, and an equivalent circuit of the spacing includes a distributed capacitor.

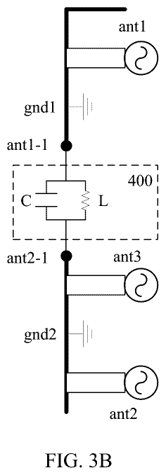

FIG. 3A is a schematic diagram of an equivalent circuit according to an embodiment of this application. The equivalent circuit includes a distributed capacitor C. One end of the distributed capacitor C is connected to the first extension branch ant1-1, and the other end is connected to the second extension branch ant2-1. The distributed capacitor C is configured to isolate signal coupling between the first antenna ant1 and the second antenna ant2 when a first resonant frequency of the first antenna ant1 and a second resonant frequency of the second antenna ant2 are within a preset frequency range. A capacitance of the distributed capacitor C is inversely proportional to a frequency within the preset frequency range.

FIG. 3B is another schematic diagram of an equivalent circuit according to an embodiment of this application. Based on the equivalent circuit shown in FIG. 3A, the equivalent circuit further includes a distributed inductor L. The distributed capacitor C and the distributed inductor L form a band-stop circuit 400. The band-stop circuit 400 has a band-stop characteristic, thereby reducing the signal coupling between the first antenna ant1 and the second antenna ant2. For example, the band-stop circuit 400 is configured to isolate the signal coupling between the first antenna ant1 and the second antenna ant2 when the first resonant frequency of the first antenna ant1 and the second resonant frequency of the second antenna ant2 are within the preset frequency range.

In the multi-antenna system, the equivalent circuit shown in FIG. 3A or the equivalent circuit shown in FIG. 3B can effectively reduce the coupling, through a floor, between the first antenna ant1 and the second antenna ant2, and improve isolation between the first antenna ant1 and the second antenna ant2.

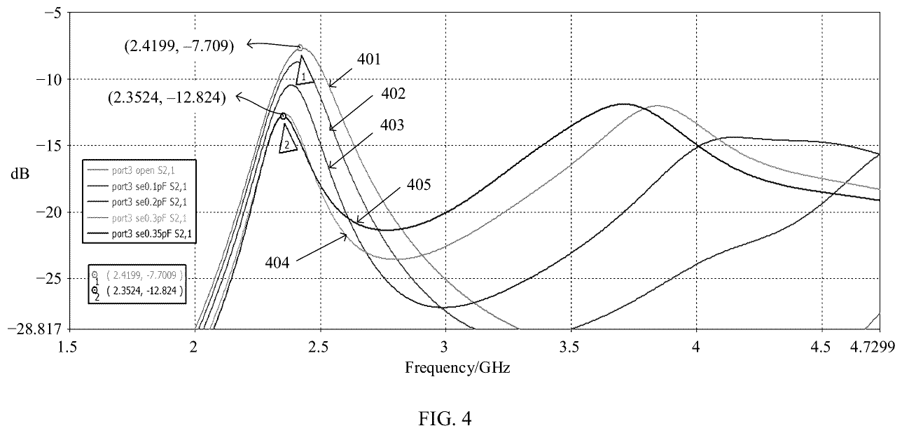

FIG. 4 is a graph showing variation of isolation between a first antenna and a second antenna according to an embodiment of this application.

In FIG. 4, a horizontal axis is frequency (Frequency) in GHz, and a vertical axis is isolation, that is, a return loss value, in dB. It should be understood that a horizontal axis and a vertical axis corresponding to all graphs in the following embodiments are the same as those in FIG. 4, and are not described in detail below.

A curve 401 is a curve of isolation between the first antenna ant1 and the second antenna ant2 when no spacing between the first extension branch ant1-1 and the second extension branch ant2-1 is not designed, that is, when the distributed capacitor is not included between the first extension branch ant1-1 and the second extension branch ant2-1.

A curve 402 is a curve of isolation between the first antenna ant1 and the second antenna ant2 when a spacing between the first extension branch ant1-1 and the second extension branch ant2-1 is designed and a capacitance of an equivalent circuit of the spacing is 0.1 pF.

A curve 403 is a curve of isolation between the first antenna ant1 and the second antenna ant2 when a spacing between the first extension branch ant1-1 and the second extension branch ant2-1 is designed and a capacitance of an equivalent circuit of the spacing is 0.2 pF.

A curve 404 is a curve of isolation between the first antenna ant1 and the second antenna ant2 when a spacing between the first extension branch ant1-1 and the second extension branch ant2-1 is designed and a capacitance of an equivalent circuit of the spacing is 0.3 pF.

A curve 405 is a curve of isolation between the first antenna ant1 and the second antenna ant2 when a spacing between the first extension branch ant1-1 and the second extension branch ant2-1 is designed and a capacitance of an equivalent circuit of the spacing is 0.35 pF.

It can be learned from FIG. 4 that, after the spacing between the first extension branch ant1-1 and the second extension branch ant2-1 is designed, that is, after the spacing is changed to change the capacitance of the distributed capacitor of the equivalent circuit, energy emitted by the second antenna ant2 and received by the first antenna ant1 can be effectively reduced, thereby improving isolation between the first antenna ant1 and the second antenna ant2. For example, when the spacing between the first extension branch ant1-1 and the second extension branch ant2-1 is designed so that the capacitance of the equivalent circuit of the spacing is 0.35 pF, the isolation between the first antenna ant1 and the second antenna ant2 can be improved by 5 dB.

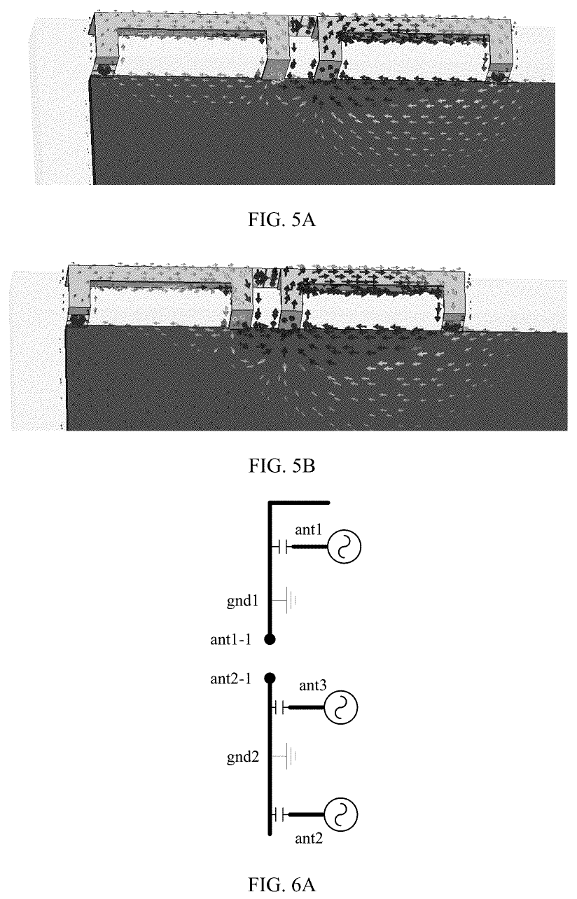

FIG. 5A is a current distribution diagram of the third antenna in the multi-antenna system according to an embodiment of this application.

FIG. 5A is a current distribution diagram of the third antenna when there is no distributed capacitor between the first extension branch ant1-1 and the second extension branch ant2-1.

FIG. 5B is another current distribution diagram of the third antenna in the multi-antenna system according to an embodiment of this application. FIG. 5B is a current distribution diagram of the third antenna when there is a distributed capacitor between the first extension branch ant1-1 and the second extension branch ant2-1. The distributed capacitor is equivalently obtained by designing a spacing between the first extension branch ant1-1 and the second extension branch ant2-1.

It can be learned from FIG. 5A and FIG. 5B that, current shown in FIG. 5A is dispersed, and isolation between the first antenna ant1 and the second antenna ant2 is poor; current shown in FIG. 5B is more concentrated than that shown in FIG. 5A, and isolation between the first antenna ant1 and the second antenna ant2 is better.

The multi-antenna system provided in this embodiment of this application reduces interference between the first antenna ant1 and the second antenna ant2 through the distributed capacitor of the equivalent circuit formed by the third antenna ant3, so that efficiency of the multi-antenna system is improved. Specifically, the third antenna ant3 includes the first extension branch ant1-1 grounded by the first antenna ant1, the second extension branch ant2-1 grounded by the second antenna ant2, and the feed of the third antenna ant3. There is the spacing between the first extension branch ant1-1 and the second extension branch ant2-1. The distributed capacitor C in the equivalent circuit of the spacing isolates the signal coupling between the first antenna ant1 and the second antenna ant2 when the first resonant frequency of the first antenna ant1 and the second resonant frequency of the second antenna ant2 are within the preset frequency range. In this way, in the multi-antenna system, when multiple antennas operate in adjacent frequency ranges or a same frequency range, the distributed capacitor C can reduce signal coupling between the multiple antennas, thereby weakening mutual interference between the multiple antennas and improving efficiency of the multi-antenna system.

Embodiments of this application do not specifically limit feeding modes of the feed of the first antenna ant1, the feed of the second antenna ant2, and the feed of the third antenna ant3. The feed of the first antenna ant1 may use a direct feeding manner or a capacitive coupling feeding manner, the feed of the second antenna ant2 may also use the direct feeding manner or the capacitive coupling feeding manner, and the feed of the third antenna ant3 may also use the direct feeding manner or the capacitive coupling feeding manner.

For ease of understanding, the following provides several schematic diagrams of the multi-antenna system.

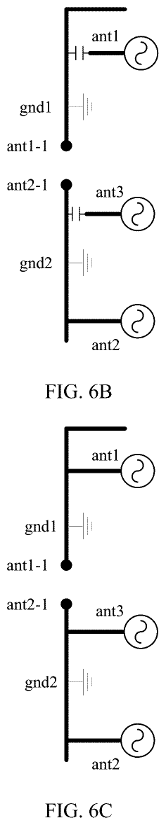

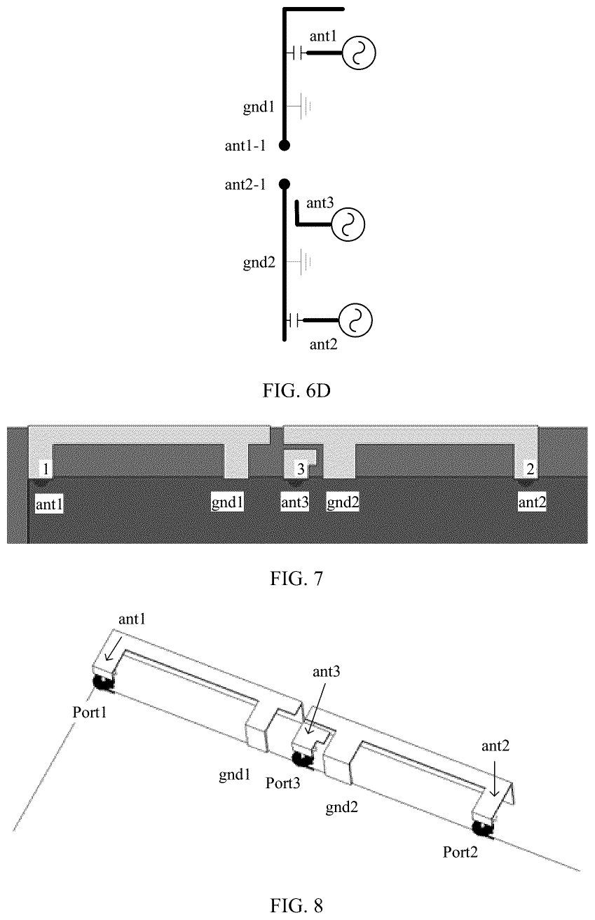

FIG. 6A is another schematic diagram of the multi-antenna system according to an embodiment of this application. In the multi-antenna system, the feed of the first antenna anti uses the capacitive coupling feeding manner, the feed of the second antenna ant2 uses the capacitive coupling feeding manner, the feed of the third antenna ant3 uses the capacitive coupling feeding manner, and the third antenna ant3 and the second antenna ant2 are used as a whole.

FIG. 6B is still another schematic diagram of the multi-antenna system according to an embodiment of this application. In the multi-antenna system, the feed of the first antenna ant1 uses the capacitive coupling feeding manner, the feed of the second antenna ant2 uses the direct feeding manner, the feed of the third antenna ant3 uses the capacitive coupling feeding manner, and the third antenna ant3 and the second antenna ant2 are used as a whole.

FIG. 6C is yet another schematic diagram of the multi-antenna system according to an embodiment of this application. In the multi-antenna system, the feed of the first antenna ant1 uses the direct feeding manner, the feed of the second antenna ant2 uses the direct feeding manner, the feed of the third antenna ant3 uses the direct feeding manner, and the third antenna ant3 and the second antenna ant2 are used as a whole.

FIG. 6D is still yet another schematic diagram of the multi-antenna system according to an embodiment of this application. In the multi-antenna system, the feed of the first antenna ant1, the feed of the second antenna ant2 and the feed of the third antenna ant3 all use the capacitive coupling feeding manner. FIG. 6D differs from FIG. 6B in that the third antenna ant implements capacitive coupling feeding by using an equivalent capacitor obtained by coupling.

Embodiments of this application do not specifically limit the first antenna ant1, the second antenna ant2, and the third antenna ant3. The first antenna ant1 may be an inverted-F antenna (Inverted-F Antenna, IFA), a composite right/left-handed (Composite Right/Left-Handed, CRLH) antenna, or a loop antenna. Similarly, the second antenna ant2 may also be an IFA antenna, a CRLH antenna, or a loop antenna, and the third antenna ant3 may also be an IFA antenna, a CRLH antenna, or a loop antenna. In this way, the multi-antenna system can use any combination of the foregoing multiple antennas.

FIG. 7 is a schematic diagram of a multi-antenna system according to an embodiment of this application. The first antenna ant1 is a CRLH antenna, the second antenna ant2 is a CRLH antenna, and the third antenna is a coupling loop antenna.

It should be noted that FIG. 7 is only an example of the foregoing combination. This is not specifically limited in embodiments of this application.

Embodiments of this application do not specifically limit forms of the first antenna ant1, the second antenna ant2, and the third antenna ant3. The first antenna ant1, the second antenna ant2, and the third antenna ant3 may be a metal frame antenna, a microstrip antenna (Metal Design Antenna, MDA), a printed circuit board (Printed Circuit Board, PCB) antenna, or a flexible printed circuit board (Flexible Printed Circuit, FPC) antenna.

FIG. 8 is a schematic diagram of a multi-antenna system according to an embodiment of this application. The first antenna ant1, the second antenna ant2, and the third antenna ant3 are flexible printed circuit board antennas.

It should be noted that FIG. 8 is described by only using an example in which the first antenna ant1, the second antenna ant2, and the third antenna ant3 are flexible printed circuit board antennas. Embodiments of this application are not limited thereto. In other embodiments of this application, the first antenna ant1, the second antenna ant2, and the third antenna ant3 may also be metal frame antennas, microstrip antennas, or printed circuit board antennas.

The structure of the multi-antenna system was described in the foregoing embodiments. With reference to the structure of the multi-antenna system, the following describes examples in which the multi-antenna system weakens the signal coupling between the first antenna and the second antenna in various situations.

First: When a distance between the ground gnd1 of the first antenna ant1 and the ground gnd2 of the second antenna ant2 remains unchanged, the spacing between the first extension branch ant1-1 and the second extension branch ant2-1 is changed.

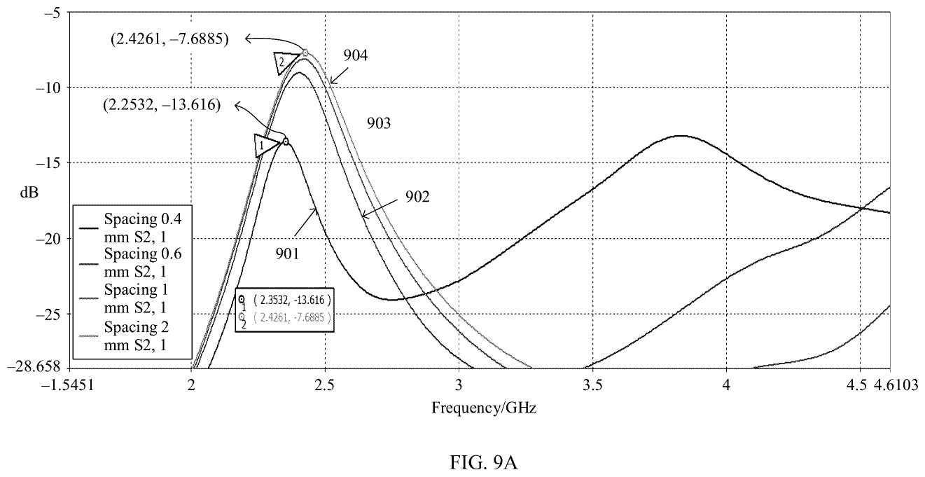

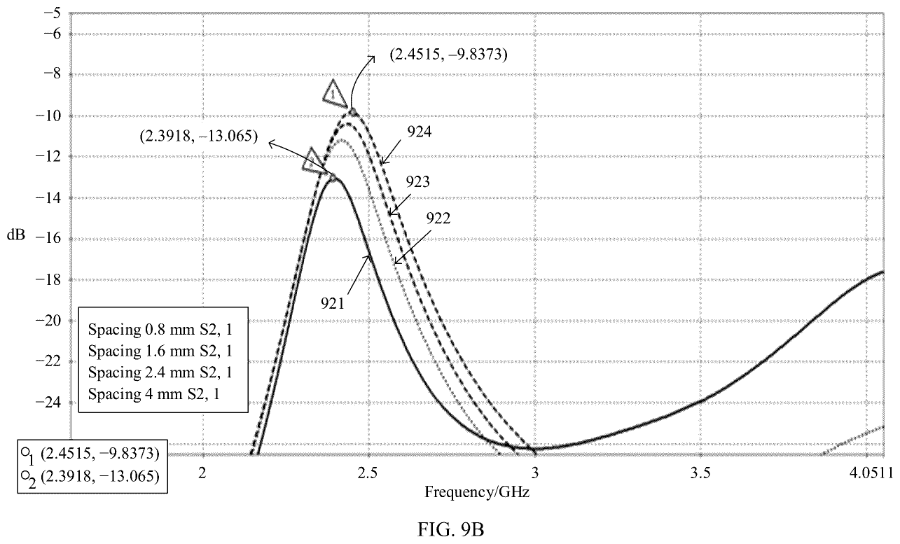

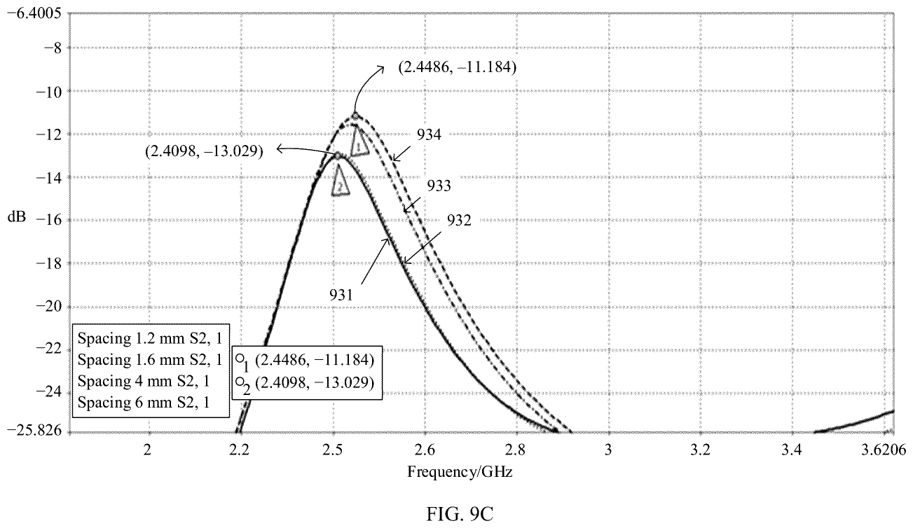

In some examples, the distance between the ground gnd1 of the first antenna anti and the ground gnd2 of the second antenna ant2 is 2 mm. FIG. 9A is a graph showing that the isolation between the first antenna and the second antenna varies with the spacing between the first extension branch ant1-1 and the second extension branch ant2-1 when the distance between the ground gnd1 of the first antenna ant1 and the ground gnd2 of the second antenna ant2 is 2 mm.

A curve 911 is a curve of the isolation between the first antenna ant1 and the second antenna ant2 when the spacing between the first extension branch ant1-1 and the second extension branch ant2-1 is 0.4 mm. A curve 912 is a curve of the isolation between the first antenna ant1 and the second antenna ant2 when the spacing between the first extension branch ant1-1 and the second extension branch ant2-1 is 0.6 mm. A curve 913 is a curve of the isolation between the first antenna ant1 and the second antenna ant2 when the spacing between the first extension branch ant1-1 and the second extension branch ant2-1 is 1 mm. A curve 914 is a curve of the isolation between the first antenna ant1 and the second antenna ant2 when the spacing between the first extension branch ant1-1 and the second extension branch ant2-1 is 2 mm.

It can be learned from FIG. 9A that, when the distance between the ground gnd1 of the first antenna ant1 and the ground gnd2 of the second antenna ant2 is 2 mm, the isolation between the first antenna ant1 and the second antenna ant2 increases as the spacing between the first extension branch ant1-1 and the second extension branch ant2-1 decreases. In this way, after the distance between the ground gnd1 of the first antenna ant1 and the ground gnd2 of the second antenna ant2 is fixed, for example, after the distance between the ground gnd1 of the first antenna ant1 and the ground gnd2 of the second antenna ant2 is fixed to 2 mm, the isolation between the first antenna ant1 and the second antenna ant2 can be changed by designing the spacing between the first extension branch ant1-1 and the second extension branch ant2-1. For example, the isolation between the first antenna ant1 and the second antenna ant2 is improved by decreasing the spacing between the first extension branch ant1-1 and the second extension branch ant2-1. As shown in FIG. 9A, the isolation between the first antenna ant1 and the second antenna ant2 can be improved by 5 dB.

In some other examples, the distance between the ground gnd1 of the first antenna ant1 and the ground gnd2 of the second antenna ant2 is 4 mm. FIG. 9B is a graph showing that the isolation between the first antenna and the second antenna varies with the spacing between the first extension branch ant1-1 and the second extension branch ant2-1 when the distance between the ground gnd1 of the first antenna ant1 and the ground gnd2 of the second antenna ant2 is 4 mm.

A curve 921 is a curve of the isolation between the first antenna ant1 and the second antenna ant2 when the spacing between the first extension branch ant1-1 and the second extension branch ant2-1 is 0.8 mm. A curve 922 is a curve of the isolation between the first antenna ant1 and the second antenna ant2 when the spacing between the first extension branch ant1-1 and the second extension branch ant2-1 is 1.6 mm. A curve 923 is a curve of the isolation between the first antenna ant1 and the second antenna ant2 when the spacing between the first extension branch ant1-1 and the second extension branch ant2-1 is 2.4 mm. A curve 924 is a curve of the isolation between the first antenna ant1 and the second antenna ant2 when the spacing between the first extension branch ant1-1 and the second extension branch ant2-1 is 4 mm.

Similarly, when the distance between the ground gnd1 of the first antenna ant1 and the ground gnd2 of the second antenna ant2 is 4 mm, the isolation between the first antenna ant1 and the second antenna ant2 increases as the spacing between the first extension branch ant1-1 and the second extension branch ant2-1 decreases.

In some other examples, the distance between the ground gnd1 of the first antenna ant1 and the ground gnd2 of the second antenna ant2 is 6 mm. FIG. 9C is a graph showing that the isolation between the first antenna and the second antenna varies with the spacing between the first extension branch ant1-1 and the second extension branch ant2-1 when the distance between the ground gnd1 of the first antenna ant1 and the ground gnd2 of the second antenna ant2 is 6 mm.

A curve 931 is a curve of the isolation between the first antenna ant1 and the second antenna ant2 when the spacing between the first extension branch ant1-1 and the second extension branch ant2-1 is 1.2 mm. A curve 932 is a curve of the isolation between the first antenna ant1 and the second antenna ant2 when the spacing between the first extension branch ant1-1 and the second extension branch ant2-1 is 1.6 mm. A curve 933 is a curve of the isolation between the first antenna ant1 and the second antenna ant2 when the spacing between the first extension branch ant1-1 and the second extension branch ant2-1 is 4 mm. A curve 934 is a curve of the isolation between the first antenna ant1 and the second antenna ant2 when the spacing between the first extension branch ant1-1 and the second extension branch ant2-1 is 6 mm.

Similarly, when the distance between the ground gnd1 of the first antenna ant1 and the ground gnd2 of the second antenna ant2 is 6 mm, the isolation between the first antenna ant1 and the second antenna ant2 increases as the spacing between the first extension branch ant1-1 and the second extension branch ant2-1 decreases.

Further, with reference to the curves of the variation of the isolation shown in FIG. 4 and FIG. 9A to FIG. 9C, it can be determined that the capacitance of the distributed capacitor C is inversely proportional to the spacing between the first extension branch ant1-1 and the second extension branch ant2-1. Specifically, when the spacing between the first extension branch ant1-1 and the second extension branch ant2-1 increases, the capacitance of the distributed capacitor C in the equivalent circuit decreases; when the spacing between the first extension branch ant1-1 and the second extension branch ant2-1 decreases, the capacitance of the distributed capacitor C in the equivalent circuit increases

In actual application, the distance between the ground gnd1 of the first antenna anti and the ground gnd2 of the second antenna ant2 is fixed first, and then the spacing between the first extension branch ant1-1 and the second extension branch ant2-1 is designed to adjust the capacitance of the distributed capacitor C in the equivalent circuit, to improve the isolation between the first antenna ant1 and the second antenna ant2.

Second: The spacing between the first extension branch ant1-1 and the second extension branch ant2-1 remains unchanged, and a distance between the ground gnd1 of the first antenna ant1 and the ground gnd2 of the second antenna ant2 is changed.

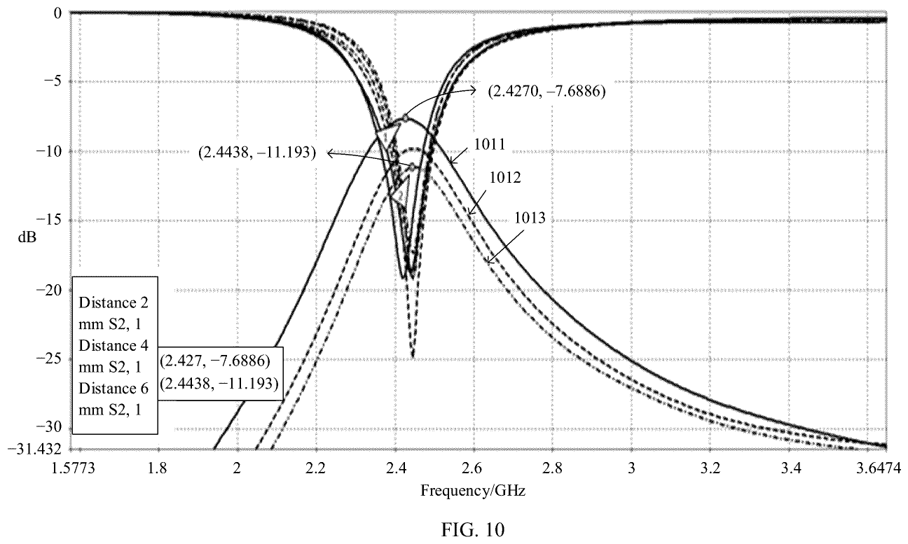

In some examples, the spacing between the first extension branch ant1-1 and the second extension branch ant2-1 is 2.4 mm. FIG. 10 shows a curve showing that the isolation between the first antenna ant1 and the second antenna ant2 varies with the distance between the ground gnd1 of the first antenna ant1 and the ground gnd2 of the second antenna ant2 when the spacing between the first extension branch ant1-1 and the second extension branch ant2-1 is 2.4 mm.

A curve 1011 is a curve of the isolation between the first antenna ant1 and the second antenna ant2 when the distance between the ground gnd1 of the first antenna ant1 and the ground gnd2 of the second antenna ant2 is 2 mm. A curve 1012 is a curve of the isolation between the first antenna ant1 and the second antenna ant2 when the distance between the ground gnd1 of the first antenna ant1 and the ground gnd2 of the second antenna ant2 is 4 mm. A curve 1013 is a curve of the isolation between the first antenna ant1 and the second antenna ant2 when the distance between the ground gnd1 of the first antenna ant1 and the ground gnd2 of the second antenna ant2 is 6 mm.

It can be learned from FIG. 10 that, when the spacing between the first extension branch ant1-1 and the second extension branch ant2-1 is 2.4 mm, the isolation between the first antenna ant1 and the second antenna ant2 is improved as the distance between the ground gnd1 of the first antenna ant1 and the ground gnd2 of the second antenna ant2 increases. In this way, after the spacing between the first extension branch ant1-1 and the second extension branch ant2-1 is fixed, for example, after the spacing between the first extension branch ant1-1 and the second extension branch ant2-1 is fixed to 2.4 mm, the isolation between the first antenna ant1 and the second antenna ant2 can be changed by designing the distance between the ground gnd1 of the first antenna ant1 and the ground gnd2 of the second antenna ant2. For example, as shown in FIG. 10, the isolation between the first antenna ant1 and the second antenna ant2 can be improved by 4 dB by increasing the distance between the ground gnd1 of the first antenna ant1 and the ground gnd2 of the second antenna ant2.

According to the principles in the first and second situations, after the distance between the ground gnd1 of the first antenna ant1 and the ground gnd2 of the second antenna ant2 increases, the isolation between the first antenna ant1 and the second antenna ant2 is improved, and an inductance of the distributed inductor L in the equivalent circuit 400 increases (refer to FIG. 3B). According to the following formula (1), the capacitance of the distributed capacitor C needs to be reduced in case of an unchanged resonant frequency.

$${f}_{0} = \frac{1}{2 π \sqrt{{L}_{0} \times {C}_{0}}} \qquad ( 1 )$$

f₀ is the resonant frequency, L₀ is the inductance of the distributed inductor L, and C₀ is the capacitance of the distributed capacitor C. The capacitance C₀ of the distributed capacitor C is inversely proportional to the spacing between the first extension branch ant1-1 and the second extension branch ant2-1. Therefore, the capacitance C₀ of the distributed capacitor C can be improved by increasing the spacing between the first extension branch ant1-1 and the second extension branch ant2-1.

Third: The spacing between the first extension branch ant1-1 and the second extension branch ant2-1 and a distance between the ground gnd1 of the first antenna ant1 and the ground gnd2 of the second antenna ant2 remain unchanged, and a coupling area between the first extension branch ant1-1 and the second extension branch ant2-1 is changed.

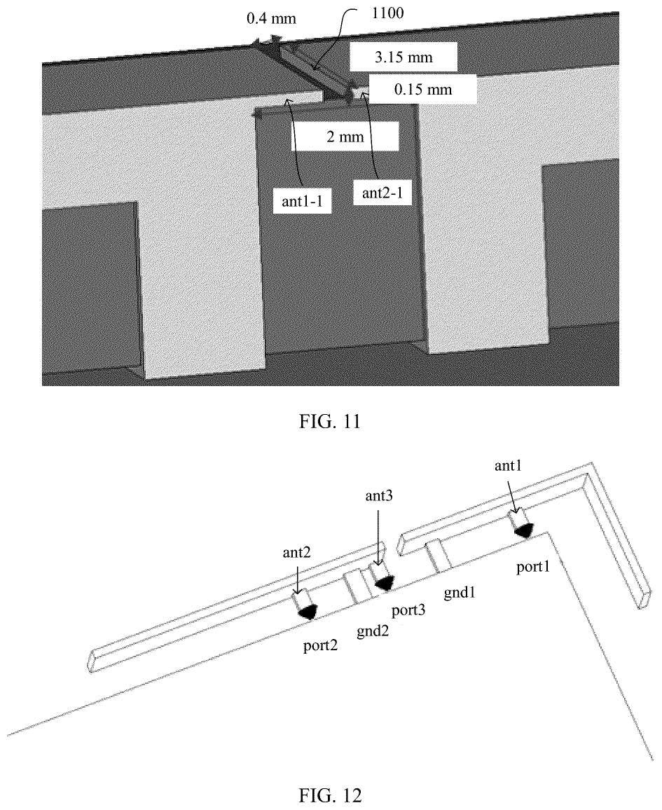

FIG. 11 is a schematic diagram of a coupling surface of the first extension branch and the second extension branch according to an embodiment of this application.

A coupling area of the coupling surface 1100 of the first extension branch ant1-1 and the second extension branch ant2-1 is 0.15×3.15=0.4725 mm².

It should be noted that the coupling area of the first extension branch ant1-1 and the second extension branch ant2-1 is not specifically limited in embodiments of this application. FIG. 11 is described by only using an example of the coupling surface 1100 with a width of 0.15 mm and a length of 3.15 mm.

In some examples, the capacitance of the distributed capacitor C is directly proportional to the coupling area of the first extension branch ant1-1 and the second extension branch ant2-1. When the spacing between the first extension branch ant1-1 and the second extension branch ant2-1 and the distance between the ground gnd1 of the first antenna ant1 and the ground gnd2 of the second antenna ant2 are both fixed, the capacitance of the distributed capacitor C can be adjusted by designing the coupling area of the coupling surface 1100. Specifically, the capacitance of the distributed capacitor C can be adjusted by the following formula (2):

$${C}_{0} = \frac{ε \times {S}_{0}}{4 k π d} \qquad ( 2 )$$

C₀ is the capacitance of the distributed capacitor C, ε is a dielectric constant of a medium between plates, S₀ is the coupling area of the coupling surface 1100, k is an electrostatic force constant, and d is the spacing between the first extension branch ant1-1 and the second extension branch ant2-1. Therefore, the capacitance C₀ of the distributed capacitor C can be adjusted by designing the coupling area So of the coupling surface 1100. Further, with reference to FIG. 4, it can be learned that an appropriate coupling area So of the coupling surface 1100 is designed to adjust the capacitance C₀ of the distributed capacitor C, so that the signal coupling between the first antenna ant1 and the second antenna ant2 can be weakened.

Of course, the multi-antenna system can be designed by using any one of the foregoing three methods, or by using a combination of multiple methods. For example, the distance between the ground gnd1 of the first antenna ant1 and the ground gnd2 of the second antenna ant2 and the coupling area between the first extension branch ant1-1 and the second extension branch ant2-1 are fixed. The capacitance of the distributed capacitor C can be adjusted by adjusting the spacing between the first extension branch ant1-1 and the second extension branch ant2-1, so that the signal coupling between the first antenna ant1 and the second antenna ant2 can be weakened.

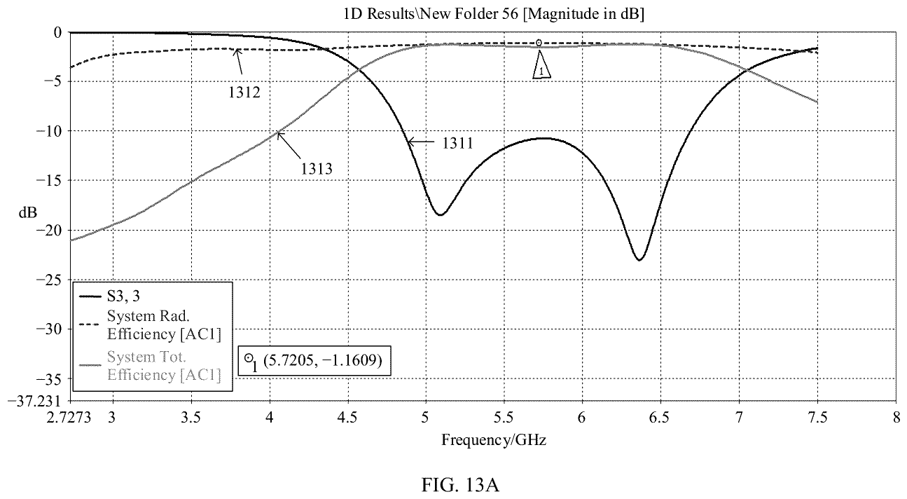

An embodiment of this application provides an example in which the first antenna ant1, the second antenna ant2, and the third antenna ant3 are all metal frame antennas. FIG. 12 is a schematic diagram of a metal frame antenna. The feed of the third antenna ant3 uses the direct feeding manner.

In some examples, the first antenna ant1 is configured to cover N41 and N78 in 5G new radio (NR) frequency bands, where a frequency range of the frequency band N41 is 2.5 GHz to 2.7 GHZ, and a frequency range of the frequency band N78 is 3.3 GHz to 3.8 GHz. The third antenna ant3 is configured to cover Wi-Fi 5G/6E. A frequency range of Wi-Fi 5G is 5.1 GHz to 5.8 GHz, and a frequency range of Wi-Fi 6E is 5.9 GHz to 7.1 GHz. The second antenna ant2 is configured to cover Wi-Fi 2.4G, where a frequency range of Wi-Fi 2.4G is 2.4 GHz to 2.5 GHz.

In some embodiments, the third antenna ant3 excites double resonance through bias feeding. For example, the third antenna ant3 excites a differential mode (Differential Mode, DM) or a common mode (Common Mode, CM) through bias feeding. In this way, the third antenna ant3 can cover a large frequency range and improve antenna efficiency by exciting the double resonance.

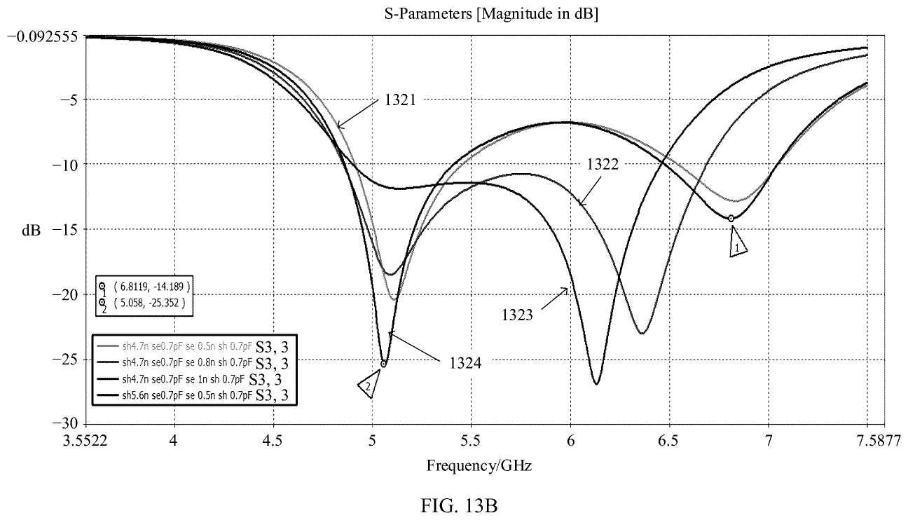

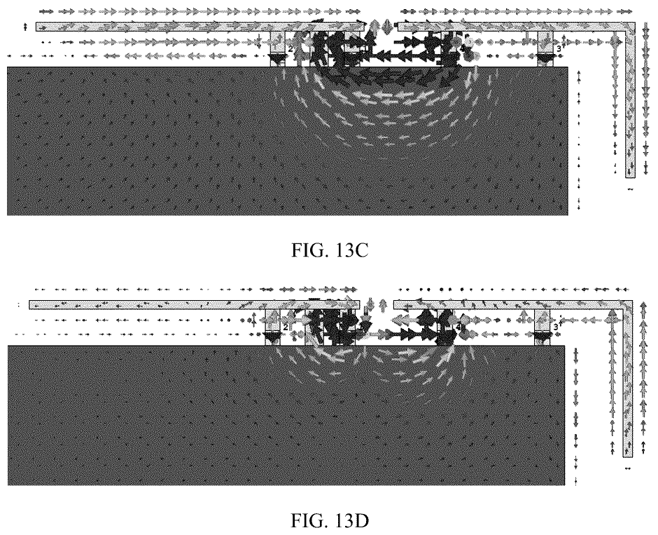

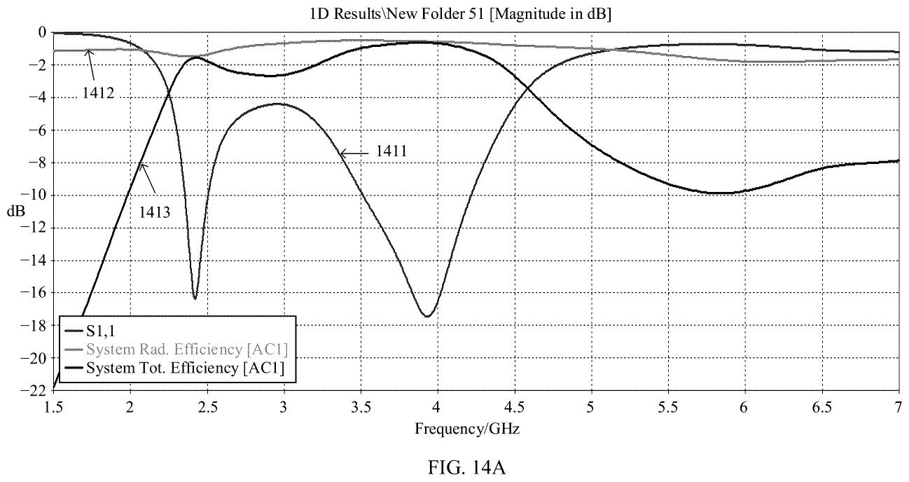

FIG. 13A is a schematic diagram showing a parameter S and antenna efficiency of the third antenna. A curve 1311 is a return loss curve of the third antenna ant3, a curve 1312 is a radiation efficiency curve of the third antenna ant3, and a curve 1313 is a system efficiency curve of the third antenna ant3. It can be learned from the figure that, the double resonance of the third antenna ant3 can cover the frequency ranges of 5G and Wi-Fi 6E.

FIG. 13B is a schematic diagram showing a return loss of the third antenna.

A curve 1321 is a return loss curve of the third antenna ant3 when a parallel inductance 1 is 4.7 nH, a series capacitance 1 is 0.7 pF, a series inductance 2 is 0.5 nH, and a parallel capacitance is 0.7 pF.

A curve 1322 is a return loss curve of the third antenna ant3 when a parallel inductance 1 is 4.7 nH, a series capacitance 1 is 0.7 pF, a series inductance 2 is 0.8 nH, and a parallel capacitance is 0.7 pF.

A curve 1323 is a return loss curve of the third antenna ant3 when a parallel inductance 1 is 4.7 nH, a series capacitance 1 is 0.7 pF, a series inductance 2 is 1 nH, and a parallel capacitance is 0.7 pF.

A curve 1324 is a return loss curve of the third antenna ant3 when a parallel inductance 1 is 5.6 nH, a series capacitance 1 is 0.7 pF, a series inductance 2 is 0.5 nH, and a parallel capacitance is 0.7 pF.

It can be learned from FIG. 13B that bandwidth and system efficiency of the third antenna ant3 can be optimized by tuning impedance matching of the third antenna ant3. In FIG. 13B, the bandwidth is wider and the system efficiency of the third antenna ant3 is better in the curve 1324.

FIG. 13C is a current distribution diagram of the third antenna. It can be learned from the figure that, when the third antenna ant3 excites the CM at 5.7 GHZ, current is distributed in a same direction.

FIG. 13D is another current distribution diagram of the third antenna. It can be learned from the figure that, when the third antenna ant3 excites the DM at 7.8 GHz, current convection is reversely distributed.

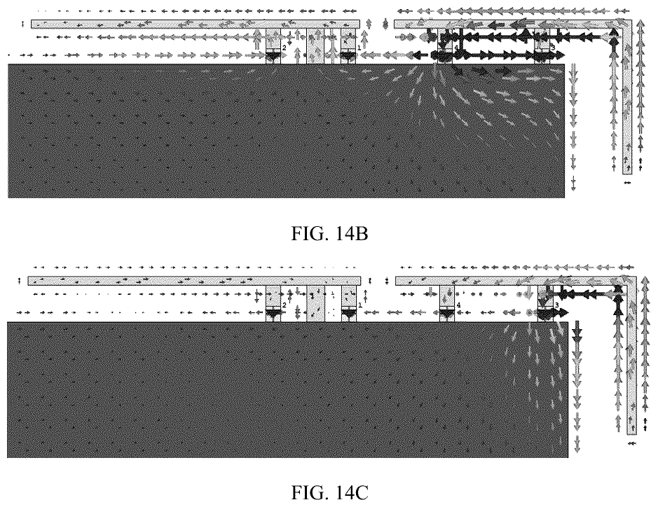

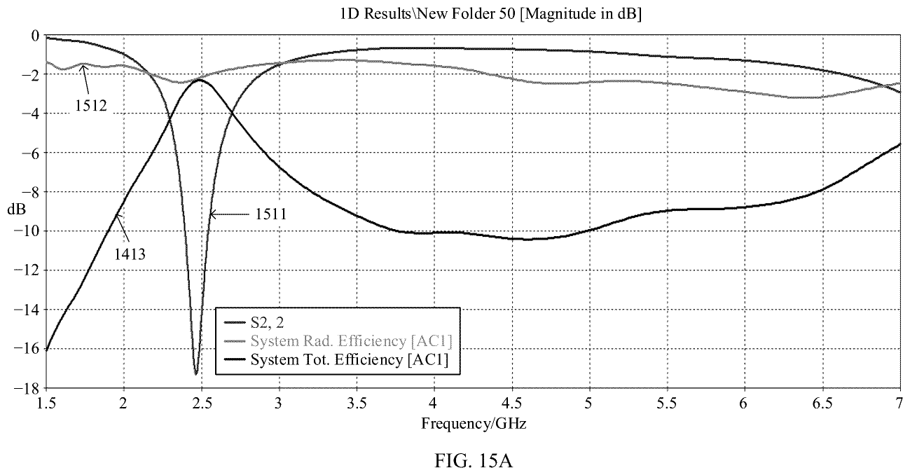

FIG. 14A is a schematic diagram showing a parameter S and antenna efficiency of the first antenna. A curve 1411 is a return loss curve of the first antenna ant1, a curve 1412 is a radiation efficiency curve of the first antenna ant1, and a curve 1413 is a system efficiency curve of the first antenna ant1.

FIG. 14B is a current distribution diagram of the first antenna. The figure is a current distribution diagram of the first antenna ant1 when the first antenna ant1 is at 2.5 GHz.

FIG. 14C is another current distribution diagram of the first antenna. The figure is a current distribution diagram of the first antenna ant1 when the first antenna ant1 is at 3.9 GHZ.

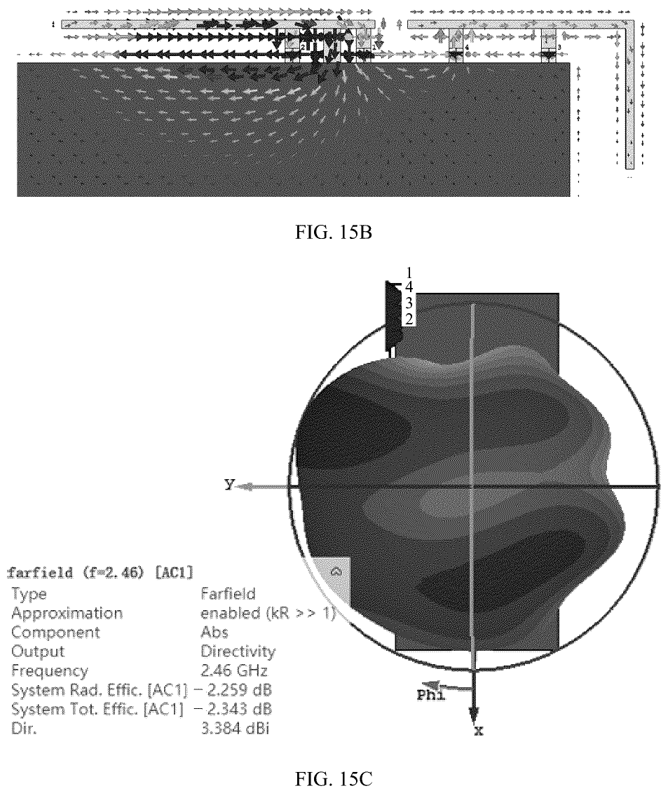

FIG. 15A is a schematic diagram showing a parameter S and antenna efficiency of the second antenna. A curve 1511 is a return loss curve of the second antenna ant2, a curve 1512 is a radiation efficiency curve of the second antenna ant2, and a curve 1513 is a system efficiency curve of the second antenna ant2.

FIG. 15B is a current distribution diagram of the second antenna. The figure is a current distribution diagram of the second antenna ant2 when the second antenna ant2 is at 2.4 GHz.

FIG. 15C is a far-field radiation pattern of the second antenna.

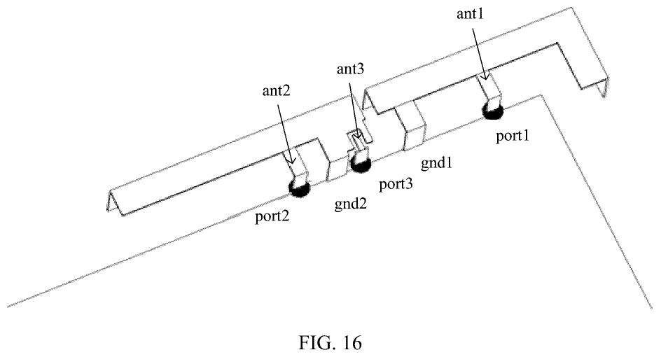

An embodiment of this application further provides an example in which the first antenna ant1, the second antenna ant2, and the third antenna ant3 are all flexible printed circuit board antennas. FIG. 16 is a schematic diagram of a flexible printed circuit board antenna. The feed of the third antenna ant3 uses the capacitive coupling feeding manner.

Similar to the multi-antenna system shown in FIG. 12, the first antenna ant1 is configured to cover N41 and N78 in 5G new radio (NR) frequency bands, where a frequency range of the frequency band N41 is 2.5 GHz to 2.7 GHZ, and a frequency range of the frequency band N78 is 3.3 GHZ to 3.8 GHz. The third antenna ant3 is configured to cover Wi-Fi 5G/6E. A frequency range of Wi-Fi 5G is 5.1 GHz to 5.8 GHz, and a frequency range of Wi-Fi 6E is 5.9 GHz to 7.1 GHz. The second antenna ant2 is configured to cover Wi-Fi 2.4G, where a frequency range of Wi-Fi 2.4G is 2.4 GHz to 2.5 GHz.

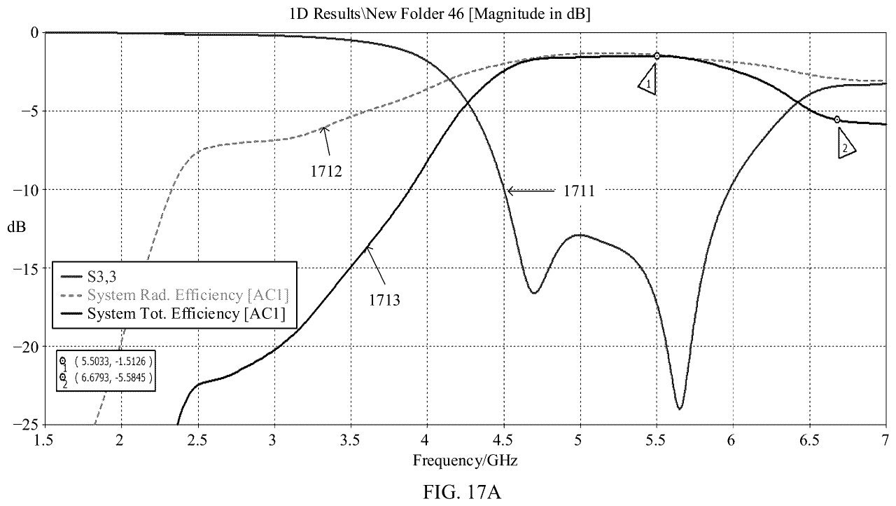

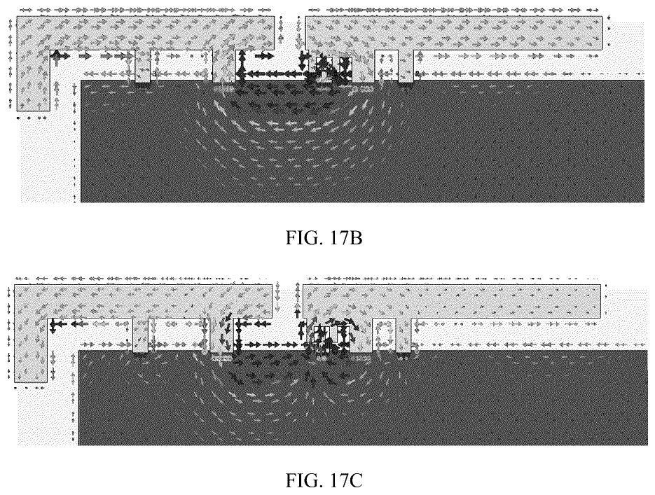

FIG. 17A is a schematic diagram showing a parameter S and antenna efficiency of the third antenna. A curve 1711 is a return loss curve of the third antenna ant3, a curve 1712 is a radiation efficiency curve of the third antenna ant3, and a curve 1713 is a system efficiency curve of the third antenna ant3. It can be learned from the figure that, the double resonance of the third antenna ant3 can cover the frequency ranges of 5G and Wi-Fi 6E.

FIG. 17B is a current distribution diagram of the third antenna. It can be learned from the figure that, when the third antenna ant3 excites the CM at 5.5 GHZ, current is distributed in a same direction.

FIG. 17C is another current distribution diagram of the third antenna. It can be learned from the figure that, when the third antenna ant3 excites the DM at 6.67 GHz, current convection is reversely distributed.

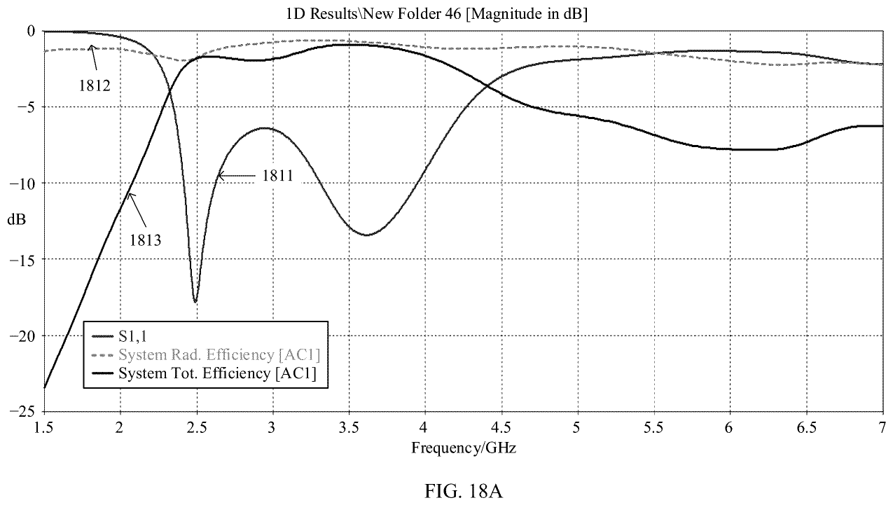

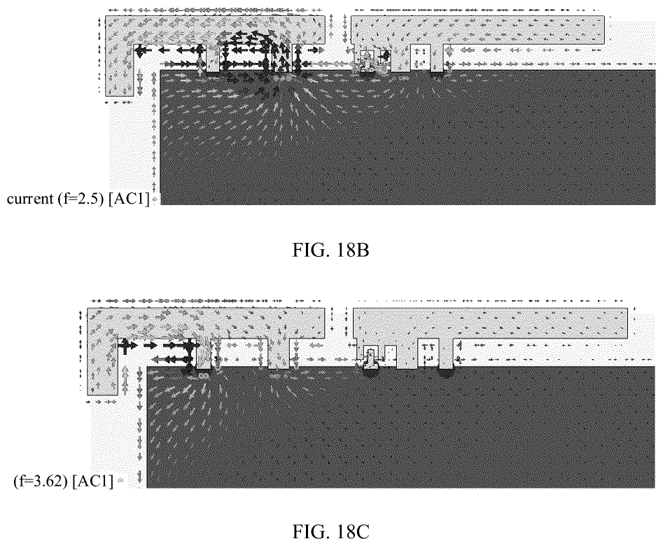

FIG. 18A is a schematic diagram showing a parameter S and antenna efficiency of the first antenna. A curve 1811 is a return loss curve of the first antenna ant1, a curve 1812 is a radiation efficiency curve of the first antenna ant1, and a curve 1813 is a system efficiency curve of the first antenna ant1.

FIG. 18B is a current distribution diagram of the first antenna. The figure is a current distribution diagram of the first antenna ant1 when the first antenna ant1 is at 2.5 GHz.

FIG. 18C is another current distribution diagram of the first antenna. The figure is a current distribution diagram of the first antenna ant1 when the first antenna ant1 is at 3.62 GHz.

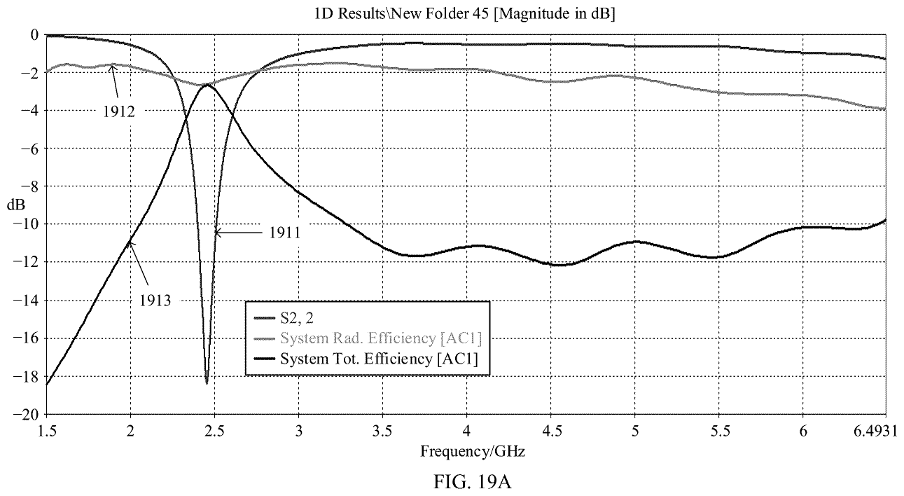

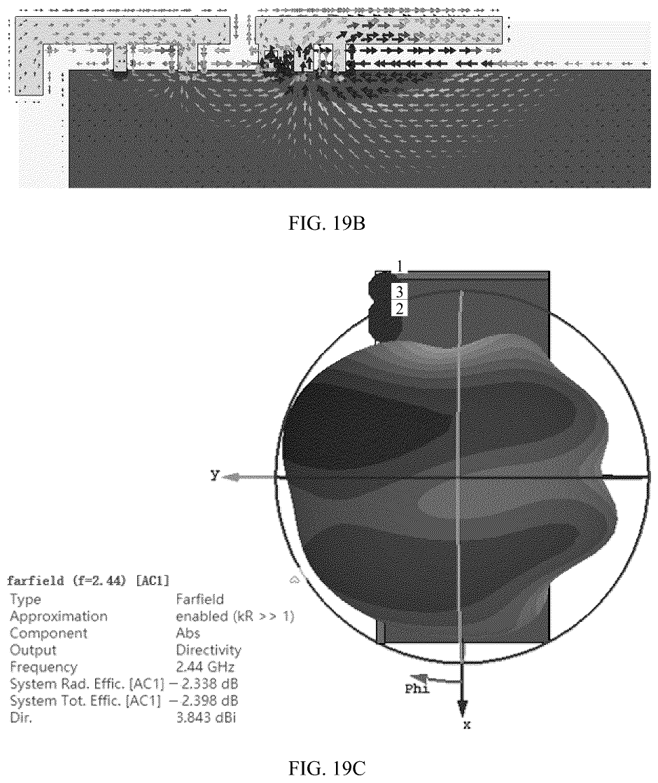

FIG. 19A is a schematic diagram showing a parameter S and antenna efficiency of the second antenna. A curve 1911 is a return loss curve of the second antenna ant2, a curve 1912 is a radiation efficiency curve of the second antenna ant2, and a curve 1913 is a system efficiency curve of the second antenna ant2.

FIG. 19B is a current distribution diagram of the second antenna. The figure is a current distribution diagram of the second antenna ant2 when the second antenna ant2 is at 2.4 GHz.

FIG. 19C is a far-field radiation pattern of the second antenna.

In the multi-antenna system provided in embodiments of this application, when multiple antennas operate in adjacent frequency ranges or a same frequency range, the distributed capacitor can reduce signal coupling between the multiple antennas, thereby weakening mutual interference between the multiple antennas and improving efficiency of the multi-antenna system. Further, the third antenna can excite the double resonance through bias feeding. In this way, not only a frequency range covered by the multi-antenna system is improved, but also efficiency of the multi-antenna system is improved.

An embodiment of this application further provides a wireless communication device. The wireless communication device includes the multi-antenna system described above, and the multi-antenna system sends and receives signals when the wireless communication device performs wireless communication.

In the multi-antenna system, the distributed capacitor can reduce signal coupling between multiple antennas when the multiple antennas operate in adjacent frequency ranges or a same frequency range, to weaken mutual interference between the multiple antennas and improve efficiency of the multi-antenna system. Therefore, communication efficiency of the wireless communication device including the multi-antenna system is higher. Further, the third antenna can excite the double resonance through bias feeding. In this way, the wireless communication device including the multi-antenna system not only covers a wider frequency range, but also has higher communication efficiency.

It should be understood that, in this application, “at least one (item)” means one or more, and “multiple” means two or more. Any simple modification and equivalent change and modification of the foregoing embodiments according to the technical essence of this application without departing from content of the technical solutions of this application still fall within the protection scope of the technical solutions of this application.

1. A multi-antenna system, applied to a wireless communication device, wherein the multi-antenna system comprises a first antenna, a second antenna, and a third antenna disposed at frame positions of the wireless communication device, and the third antenna and the first antenna share a first radiator of the first antenna, or the third antenna and the second antenna share a second radiator of the second antenna;
the first radiator comprises a first extension branch, wherein the first extension branch is next to the second antenna;
the second radiator comprises a second extension branch, wherein the second extension branch is next to the first antenna;
a ground of the first antenna is disposed at the first extension branch, a ground of the second antenna is disposed at the second extension branch, a feed of the first antenna is disposed on the first radiator on a side of the first radiator that is farthest from a first end of the second antenna, and a feed of the second antenna is disposed on the second radiator on a side of the second radiator that is farthest from a second end of the first antenna;
a feed of the third antenna is disposed at the first extension branch or the second extension branch; and the feed of the third antenna is located between the ground of the first antenna and the ground of the second antenna, the third antenna and the first antenna share the ground of the first antenna, and the third antenna and the second antenna share the ground of the second antenna; and
there is a spacing between the first extension branch and the second extension branch, and an equivalent circuit of the spacing comprises a distributed capacitor, wherein
the distributed capacitor is configured to isolate signal coupling between the first antenna and the second antenna when a first resonant frequency of the first antenna and a second resonant frequency of the second antenna are within a preset frequency range, and a capacitance of the distributed capacitor is inversely proportional to a frequency within the preset frequency range.

2. The multi-antenna system according to claim 1, wherein the third antenna is configured to excite double resonance through bias feeding.

3. (canceled)

4. The multi-antenna system according to claim 1, wherein the capacitance of the distributed capacitor is inversely proportional to the spacing.

5. The multi-antenna system according to claim 1, wherein the capacitance of the distributed capacitor is directly proportional to a coupling area of the first extension branch and the second extension branch.

6. The multi-antenna system according to claim 4, wherein the equivalent circuit further comprises a distributed inductor, and the distributed capacitor and the distributed inductor form a band-stop circuit, wherein the band-stop circuit is configured to reduce signal coupling between the first antenna and the second antenna.

7. The multi-antenna system according to claim 1, wherein the feeds of the first antenna, the second antenna, and the third antenna use a direct feeding manner or a capacitive coupling feeding manner.

8. The multi-antenna system according to claim 1, wherein the first antenna, the second antenna, and the third antenna are any one of the following:
an inverted-F antenna, a composite right/left-handed antenna, or a loop antenna, wherein the first antenna, the second antenna, and the third antenna are implemented in at least one of the following forms:
a metal-frame antenna, a microstrip antenna, a printed circuit board antenna, or a flexible printed circuit board antenna.

9. The multi-antenna system according to claim 1, wherein the double resonance of the third antenna covers frequency ranges of 5.1 GHz to 5.8 GHz and 5.9 GHz to 7.1 GHz.

10. A wireless communication device, comprising the multi-antenna system according to claim 1, wherein the multi-antenna system is configured to send and receive signals when the wireless communication device performs wireless communication.

11. A multi-antenna system, applied to a wireless communication device, wherein the multi-antenna system comprises a first antenna, a second antenna, and a third antenna disposed at frame positions of the wireless communication device, and the third antenna and the first antenna share a first radiator of the first antenna, or the third antenna and the second antenna share a second radiator of the second antenna;
the first radiator comprises a first extension branch, wherein the first extension branch is next to the second antenna;
the second radiator comprises a second extension branch, wherein the second extension branch is next to the first antenna;
a ground of the first antenna is disposed at the first extension branch, a ground of the second antenna is disposed at the second extension branch, a feed of the first antenna is disposed on the first radiator and on a side of the first radiator that is farthest from a first end of the second antenna, and a feed of the second antenna is disposed on the second radiator and on a side of the second radiator that is farthest from a first end of the first antenna;
when the third antenna and the first antenna share the first radiator of the first antenna, a feed of the third antenna is disposed at the first extension branch; or when the third antenna and the second antenna share the second radiator of the second antenna, a feed of the third antenna is disposed at the second extension branch;
the feed of the third antenna is located between the ground of the first antenna and the ground of the second antenna, the third antenna and the first antenna share the ground of the first antenna, and the third antenna and the second antenna share the ground of the second antenna; and
there is a spacing between the first extension branch and the second extension branch, and an equivalent circuit of the spacing comprises a distributed capacitor, wherein
the distributed capacitor is configured to isolate signal coupling between the first antenna and the second antenna when a first resonant frequency of the first antenna and a second resonant frequency of the second antenna are within a preset frequency range, and a capacitance of the distributed capacitor is inversely proportional to a frequency within the preset frequency range.

12. The multi-antenna system according to claim 11, wherein the third antenna is configured to excite double resonance through bias feeding.

13. The multi-antenna system according to claim 11, wherein the capacitance of the distributed capacitor is inversely proportional to the spacing.

14. The multi-antenna system according to claim 11, wherein the capacitance of the distributed capacitor is directly proportional to a coupling area of the first extension branch and the second extension branch.

15. The multi-antenna system according to claim 13, wherein the equivalent circuit further comprises a distributed inductor, and the distributed capacitor and the distributed inductor form a band-stop circuit, wherein the band-stop circuit is configured to reduce signal coupling between the first antenna and the second antenna.

16. The multi-antenna system according to claim 11, wherein the feeds of the first antenna, the second antenna, and the third antenna use a direct feeding manner or a capacitive coupling feeding manner.

17. The multi-antenna system according to claim 11, wherein the first antenna, the second antenna and the third antenna are any one of the following:
an inverted-F antenna, a composite right/left-handed antenna, or a loop antenna, wherein the first antenna, the second antenna, and the third antenna are implemented in at least one of the following forms:
a metal-frame antenna, a microstrip antenna, a printed circuit board antenna, or a flexible printed circuit board antenna.

18. The multi-antenna system according to claim 12, wherein the double resonance of the third antenna covers frequency ranges of 5.1 GHz to 5.8 GHz and 5.9 GHz to 7.1 GHz.
